(19) United States
(12) Patent Application Publication
(10) Pub. No.: US 2025/0062860 A1
(43) Pub. Date: Feb. 20, 2025

(54) FSK AND LAN PROTOCOL CONVERSION APPARATUS FOR RAIL TRANSIT SIGNAL SYSTEM

(71) Applicant: CASCO SIGNAL LTD., Shanghai (CN)

(72) Inventors: Donghai WANG, Shanghai (CN); Xiaoyong WANG, Shanghai (CN); Jianquan LI, Shanghai (CN); Yi HAN, Shanghai (CN); Ronghua HU, Shanghai (CN); Huaxiang LIU, Shanghai (CN); Tao HAN, Shanghai (CN)

(21) Appl. No.: 18/706,690

(22) PCT Filed: Nov. 30, 2022
(86) PCT No.: PCT/CN2022/135630

§ 371 Date: May 1, 2024

(30) Foreign Application Priority Data
Sep. 6, 2022 (CN) 202211082163.X

(51) Int. Cl. H04L 1/00; H04L 7/033; H04L 27/12

(52) U.S. Cl. CPC H04L 1/0063; H04L 7/0331; H04L 27/12

(57) ABSTRACT

The present invention relates to an FSK and LAN protocol conversion apparatus for a rail transit signal system, wherein the apparatus includes: a control instruction sending module (TC); a device state receiving module (TK); a data validity check module (VD) connected with the TC and the TK respectively; a first Ethernet redundant communication module (LAN A) connected with the VD; a second Ethernet redundant communication module (LAN B) connected with the VD; and a system configuration and maintenance module (MAN) connected with the above modules respectively. Compared with the prior art, the present invention has the advantage of implementing network access with a new ATS system of a control center on the basis of an original system, with minimized capital investment and maximized utilization of the existing station device.

### FIELD OF TECHNOLOGY

The present invention relates to a rail transit signal system, and in particular to an FSK and LAN protocol conversion apparatus for a rail transit signal system.

### BACKGROUND

On Jan. 9, 2021, a big fire broke out in a first command center PCCI of metro of the Mexico City. The entire building was burned down, which caused complete paralysis of center train running command systems of line 1 to line 6. After the fire, operation of line 1 to line 6 was in a state of commanding train running under a relay interlocking unit in a station, and the control center used CCTV to monitor the position of a train. Low train command efficiency led to a significant decline in the capacity of the six subway lines, and a train operation interval was increased from 2 minutes to 5 minutes. The metro company urgently needed to restore a train monitoring function of the control center.

The line 1 to line 6 in the Mexico City was built a long time ago, wherein the earliest line 1 was built in 1969 and is an Olympic Games supporting project of the Mexico City, while the latest line 6 was built in 1983 and has a history of nearly 40 years. Each of the train running command systems of the above six subway lines adopt a complete set of devices which are a relay interlocking (Senalizacion)+a train control system PA135 (Pilotaje Automatico 135 KHZ)+a centralized instruction system MC (Mando Centralizado) based on FSK information transmission and from the SGTE Systemes & Services company of France, so as to realize centralized train operation safety control and dispatching.

The SGTE train running command system takes the MC as a core, and each related subsystem is connected with the MC by a hard wire connection for driving collection. A communication manner of different device installation sites, such as between the control center and the MC of the station, is FSK. A block diagram of the system is shown in FIG. 1.

The parts of the control center destroyed by the fire are mainly a dispatching board (used to dispatch and issue a control command, such as route establishment), a transit control optical panel TCO (used to observe a position of a train on a line and a signal state) and an auxiliary command board, a TCO and station interlocking and a control center MC cabinet interfaced with the PA135, while the MC, the relay interlocking and a PA135 cabinet at the station are intact. In addition, since the original control center building has been reduced to ruins in the fire, an FSK information transmission line between the control center MC and the station MC has also been destroyed. The metro company of the Mexico City sets up a new control center in the Security Center C5 (Centro de control 5) of the Mexico City. Therefore, how to realize the effective communication between the six lines and the new control center has become a technical problem that needs to be solved.

### SUMMARY

The purpose of the present invention is to provide an FSK and LAN protocol conversion apparatus for a rail transit signal system so as to overcome the defects in the prior art. With minimum capital investment, maximum utilization of an existing station device, the apparatus realizes a network access with a new ATS system of a control center on the basis of an original system.

The purpose of the present invention can be realized by the following technical solutions:

According to one aspect of the present invention, provided is an FSK and LAN protocol conversion apparatus for a rail transit signal system, wherein the apparatus comprises:
a control instruction sending module;
a device state receiving module;
a data validity check module connected with the control instruction sending
module and the device state receiving module respectively;
a first Ethernet redundant communication module connected with the data validity check module;
a second Ethernet redundant communication module connected with the data validity check module; and
a system configuration and maintenance module connected with the above modules respectively.

As a preferred technical solution, the control instruction sending module comprises:
an information coding and framing sub-module;
an FSK modulation sub-module; and
a D/A conversion sub-module.

As a preferred technical solution, a working process of the control instruction sending module is specifically as follows:
(101) acquiring information data and a check code from the data validity check module;
(102) generating, by the information coding and framing sub-module, a data stream according to a frame format;
(103) performing, by the FSK modulation sub-module, FSK modulation on the generated data stream; and
(104) converting, by the D/A conversion sub-module, the FSK modulated data and sending the converted data to a station MC.

As a preferred technical solution, a format of data that the control instruction sending module sends to the station MC is as follows:
(a) a single information frame contains 28-bit information, including 1 bit of a word start identifier, 20 bits of information bits, 1 bit of a parity check bit, and 6 bits of an information error tolerance code;
(b) 10 single information frames are spliced into 1 complete data packet, and a 28-bit synchronous information packet is added uniformly in a header, and then the obtained packet is sent to the station MC through FSK communication; and
(c) each packet of data has 200 effective information bits, and a transmission cycle is 770 ms.

As a preferred technical solution, a specific process of performing, by the FSK modulation sub-module, FSK modulation on the generated data stream is as follows:
an up-sampling process, a molding filtering process, a 3-stage CIC interpolation process, a phase accumulation process and an orthogonal modulation process.

As a preferred technical solution, the device state receiving module comprises: an information decoding and deframing sub-module:

an FSK demodulation sub-module; and an A/D conversion sub-module.

As a preferred technical solution, a working process of the device state receiving module is specifically as follows:
(201) receiving data from a station MC, converting, by the A/D conversion sub-module, the received data, and sending the converted data to the FSK demodulation sub-module;
(202) performing, by the FSK demodulation sub-module, FSK demodulation on the received data; and
(203) performing, by the information decoding and deframing sub-module, frame synchronization, bit synchronization and decision decoding in turn on the data obtained through the FSK demodulation.

As a preferred technical solution, a specific process of performing, by the FSK demodulation sub-module, FSK demodulation on the received data is as follows:
a down-conversion process, a low-pass filtering process, a matching filtering process, a 3-stage CIC extraction process, a phase-locked loop process and a baseband signal generating process.

As a preferred technical solution, the frame synchronization in (203) is specifically as follows:
calculating correlation values between baseband signal samples outputted by a phase-locked loop and a synchronization sequence to find a synchronization position.

As a preferred technical solution, the bit synchronization in (203) is specifically as follows:
performing the bit synchronization according to a frame synchronization position to obtain complete data of 11 words.

As a preferred technical solution, the decision decoding in (203) is specifically as follows:
performing a decoding operation, and delivering information bits and check bits of 10 words from word 2 to word 11 to the data validity check module for processing.

As a preferred technical solution, the data validity check module comprises: a data error tolerance code generating sub-module; and a data error tolerance code check sub-module.

As a preferred technical solution, the data error tolerance code generating sub-module divides acquired instruction information into 10 words according to an MC framing manner, generates 6-bit check bits for each word by a generating polynomial according to a fixed coding rule, and then splices the information and uniformly sends the spliced information to the control instruction sending module for a framing operation.

As a preferred technical solution, the data error tolerance code check sub-module acquires 10 information words and a 6-bit check code stream per information word from the device state receiving module, implements a data check operation on content of each control word and a corresponding check code according to the generating polynomial, and if the check is correct, discards the 6-bit check code and repackages 200 bit pure data and sends to the Ethernet redundant communication module, and if the check is not correct, sends an all-zero packet to the Ethernet redundant communication module and sets an identification bit to identify a data check error.

As a preferred technical solution, the first Ethernet redundant communication module and the second Ethernet redundant communication module are two completely independent modules, each of which has two physical connections with a redundant red and blue Ethernet, so as to ensure that two redundant communication channels are still maintained with an ATS system of a control center in a case of a single module fault; and
the FSK and LAN protocol conversion apparatus maintains 4 independent IP continuous communications with an ATS gateway computer at the same time.

As a preferred technical solution, read and write operations of the first Ethernet redundant communication module and the second Ethernet redundant communication module are separated, and only one master IP from 4 IPs reads and writes at the same time at a timing, and an ATS instruction is delivered to the MC to ensure the uniqueness of an MC write operation, and the remaining 3 IPs only feed back an MC state to the ATS in response to an ATS read request.

As a preferred technical solution, the system configuration and maintenance module is used to refresh an internal component of the apparatus, and the system configuration and maintenance module connects a diagnostic software of a PC through a network or a serial port to monitor an input or output interface of each module in real time, and bypasses an ATS input to force the interface to output specific control code bits.

As a preferred technical solution, the apparatus further comprises an external interface which specifically comprises:
4 mutually independent Ethernet interfaces with an ATS gateway of a control center; and
two mutually independent FSK communication interfaces with a station MC cabinet.

Compared with the prior art, the present invention has the following advantages:
(1) The present invention develops a set of general station FSK interface device, which directly interfaces with the station MC device, thus replacing the original control center MC and realizing the information collection and driving interface with the existing station system; and the device also has the Ethernet protocol conversion function, and can convert FSK information into Ethernet application layer information, which is convenient for information transmission and processing and realizes Ethernet communication between the new control center and the stations on line 1 to line 6;
(2) The present invention is developed based on a FPGA programmable device, and all the functions covered by the original MC system cabinet, such as information coding, decoding, error tolerant processing, FSK signal modulation and demodulation are integrated in a single device; and compared with the existing MC control cabinet, the volume of the module is greatly reduced and the module can be encapsulated in a 1U device chassis; and compared with the MC cabinet, a reliability index of the system has also been greatly improved;
(3) The communication module of the module in the present invention adopts the redundant Ethernet interface, which is convenient to realize the remote communication with the new built control center: based on the redundant dual network 4 IP architecture, the availability of communication between the control center and the station is ensured to a greatest extent; and the network communication protocol is developed based on a standard Modbus TCP/IP, and special requirements of the project are added under the mature software architecture;
(4) The module design of the present invention adopts a standardized solution, which only implements the process processing of data communication between the ATS and the MC, and has nothing to do with the configuration of the station itself, so it is applicable to all stations on line 1 to line 6 using the MC control cabinets, and would not cause one configuration per station, which is convenient for system maintenance; and
(5) The system configuration and maintenance module of the present invention supports various interfaces such as a serial port, USB and a network interface, can realize a remote upgrade of the device through the network, and provides a function of real-time detection of input information and a compulsory output, and is convenient for on-site debugging.

### BRIEF DESCRIPTION OF THE DRAWINGS

FIG. 1 is a schematic diagram of an SGTE train running command system centered on MCs;

FIG. 2 is a structure diagram of an FSK and LAN protocol conversion apparatus in the present invention:

FIG. 3 is a working flow chart of a control instruction sending module (TC) in the present invention;

FIG. 4 is a working flow chart of a device state receiving module (TK) in the present invention:

FIG. 5 is a schematic diagram of a single information word format in the present invention:

FIG. 6 is a schematic diagram of an FSK framing format in the present invention; and

FIG. 7 is a schematic diagram of an Ethernet connection between the FSK/LAN apparatus and an ATS of a control center in the present invention.

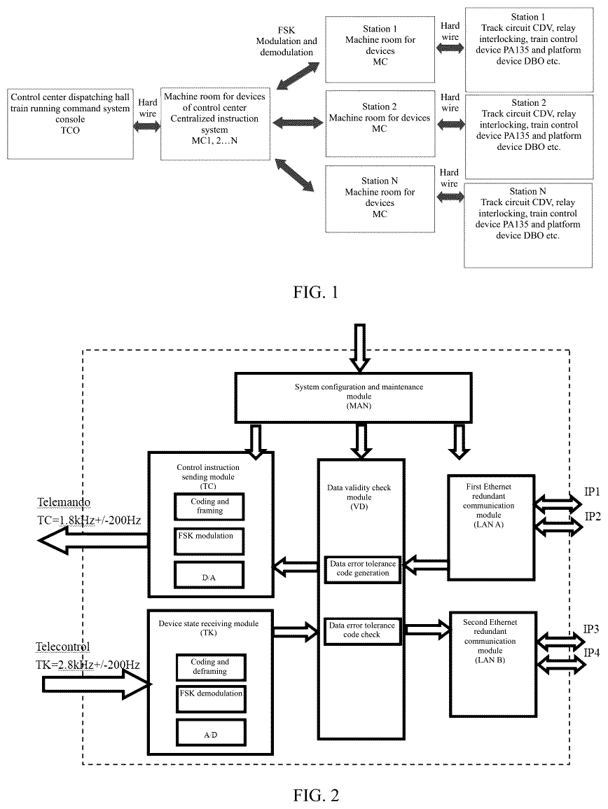

### DESCRIPTION OF THE EMBODIMENTS

The following is a clear and complete description of the technical solutions in the embodiments of the present invention in combination with the drawings attached to the embodiments of the present invention. Obviously, the embodiments described are a part of the embodiments of the present invention, but not the whole embodiments. Based on the embodiments of the present invention, all other embodiments obtained by a person skilled in the art without creative labor shall fall within the protection scope of the present invention.

The overall technical solution of the present invention is as follows:
1. remaining a station MC, a relay interlocking, a PA135, a wayside track circuit and loop, a signal, a carborne device;
2. according to technical requirements of an existing SGTE central control system, developing a set of an ATS train running command system of a control center to replace an original system TCO and a scheduling board, wherein the system would interface with the relay interlocking and the PA135 device to cover functions of an existing train running monitoring system; and
3. realizing Ethernet transmission between the control center and an FSK interface device of the station, and ensuring the same level of real-time and availability of information as the existing system through a design of a supporting network transmission protocol.

Based on the above requirements, the present invention develops a set of general station FSK interface device, which directly interfaces with the station MC device, thus replacing the original control center MC and realizing the information collection and driving interface with the existing station system; and the device also has the Ethernet protocol conversion function, and can convert FSK information into Ethernet application layer information, which is convenient for information transmission and processing and realizes Ethernet communication between the new control center and the stations on line 1 to line 6.

As shown in FIG. 2, an FSK and LAN protocol conversion apparatus for a rail transit signal system, wherein the apparatus comprises:
a control instruction sending module TC;
a device state receiving module TK;
a data validity check module VD connected with the control instruction sending
module TC and the device state receiving module TK respectively;
a first Ethernet redundant communication module LAN A connected with the data validity check module VD;
a second Ethernet redundant communication module LAN B connected with the data validity check module VD; and
a system configuration and maintenance module MAN connected with the above modules respectively.

The FSK and LAN protocol conversion apparatus of the present invention mainly realizes the following functions:
(1) Realizing FSK based communication with an existing MC cabinet in a station, periodically (770 ms) receiving a relay interlocking variable state collected by an collection board inside the MC cabinet via a hard wire connection through the Telecontrol (TK, 2.8 kHz+/−200 Hz), such as track circuit CDV occupation/clearance, switch left/right hand direction, red/white/green of a signal, maintenance pit occupation/clearance: an outdoor platform device, such as an activation/cancellation state of a DBO platform train detention device, a terminal turn-back station train number input device; and PA135 track section initialization activation/cancellation, etc. After the above information is processed by an FSK/LAN module, it is sent to a new built ATS system in a control center through a redundant Ethernet network. After real-time processing by an ATS application server in the control center, it is sent to a new built large screen and a dispatcher workstation IHM in a dispatching hall for display.
(2) Realizing a communication interface based on the redundant Ethernet network with the new built ATS system of the control center ATS, periodically (1000 ms) receiving ATS system control instructions, such as route establishment/cancellation, DBO platform train detention device activation/cancellation instructions, PA135 train interval operation level selection (normal, acceleration 1, acceleration 2, slow running mode, rainy day mode), terminal platform departure time indication. After the above information is processed by the FSK/LAN module, it would be delivered to an MC device of the station through Telemando (TC, 1.8 kHz+/−200 Hz) based on FSK communication, so as to realize the transmission of control instructions of the existing signal system.

The control instruction sending module TC comprises: an information coding and framing sub-module: an FSK modulation sub-module; and a D/A conversion sub-module.

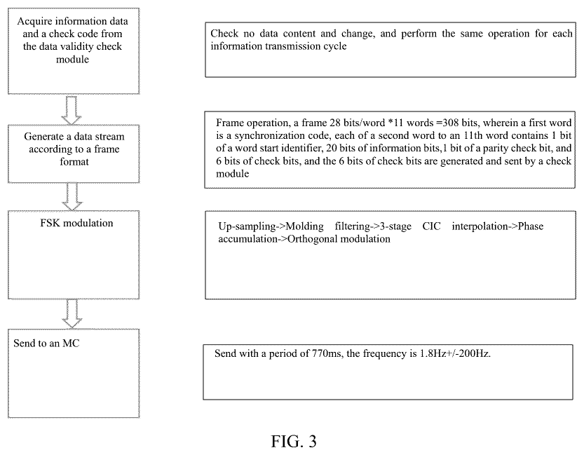

As shown in FIG. 3, a working process of the control instruction sending module TC is specifically as follows:
(101) acquiring information data and a check code from the data validity check module;
(102) generating, by the information coding and framing sub-module, a data stream according to a frame format;
(103) performing, by the FSK modulation sub-module, FSK modulation on the generated data stream; and
(104) converting, by the D/A conversion sub-module, the FSK modulated data and sending the converted data to a station MC.

A format of data that the control instruction sending module TC sends to the station MC is as follows:
(a) a single information frame contains 28-bit information, including 1 bit of a word start identifier, 20 bits of information bits, 1 bit of a parity check bit, and 6 bits of an information error tolerance code;
(b) 10 single information frames are spliced into 1 complete data packet, and a 28-bit synchronous information packet is added uniformly in a header, and then the obtained packet is sent to the station MC through FSK communication; and
(c) each packet of data has 200 effective information bits, and a transmission cycle is 770 ms.

A specific process of performing, by the FSK modulation sub-module, FSK modulation on the generated data stream is as follows:
an up-sampling process, a molding filtering process, a 3-stage CIC interpolation process, a phase accumulation process and an orthogonal modulation process.

The device state receiving module TK comprises: an information decoding and deframing sub-module: an FSK demodulation sub-module; and an A/D conversion sub-module.

As shown in FIG. 4, a working process of the device state receiving module TK is specifically as follows:
(201) receiving data from a station MC, converting, by the A/D conversion sub-module, the received data, and sending the converted data to the FSK demodulation sub-module;
(202) performing, by the FSK demodulation sub-module, FSK demodulation on the received data; and
(203) performing, by the information decoding and deframing sub-module, frame synchronization, bit synchronization and decision decoding in turn on the data obtained through the FSK demodulation.

A specific process of performing, by the FSK demodulation sub-module, FSK demodulation on the received data is as follows:
a down-conversion process, a low-pass filtering process, a matching filtering process, a 3-stage CIC extraction process, a phase-locked loop process and a baseband signal generating process.

The frame synchronization in (203) is specifically as follows: calculating correlation values between baseband signal samples outputted by a phase-locked loop and a synchronization sequence to find a synchronization position.

The bit synchronization in (203) is specifically as follows: performing the bit synchronization according to a frame synchronization position to obtain complete data of 11 words.

The decision decoding in (203) is specifically as follows: performing a decoding operation, and delivering information bits and check bits of 10 words from word 2 to word 11 to the data validity check module for processing.

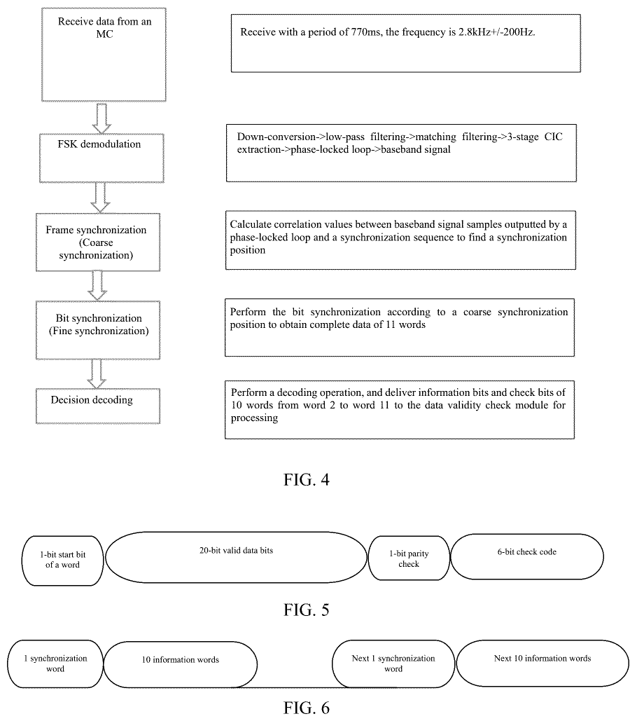

A data flow communication format between the MC, FSK and LAN protocol conversion apparatus is shown in FIG. 5 and FIG. 6, and the data format between them fully follows a data format of FSK communication between MC and MC under the existing SGTE system framework.

The data validity check module VD comprises: a data error tolerance code generating sub-module; a data error tolerance code check sub-module.

The data validity check module mainly completes the following functions:

(A) Transmitting data check code generation and delivery: acquiring instruction information sent by the center ATS system from a Master IP of the Ethernet redundant communication module, a total of 200 bits, according to an MC framing manner, dividing them into 10 words, with 20 bits per word. Generating 6-bit check bits for each word by a generating polynomial according to a fixed coding rule, and then splicing the information and uniformly sends the spliced information to the control instruction sending module (TC) for a framing operation.

(B) Received data check code check and upload: acquiring 10 information words+a 6-bit check code stream per each information word from the device state receiving module (TK), implementing a data check operation on content of each control word and a corresponding check code according to the generating polynomial, and if the check is correct, discarding the 6-bit check code and repackaging 200 bit pure data and sending to the Ethernet redundant module A/B, and if the check is not correct, sending an all-zero packet to the Ethernet redundant communication module A/B and setting an identification bit to identify a data check error.

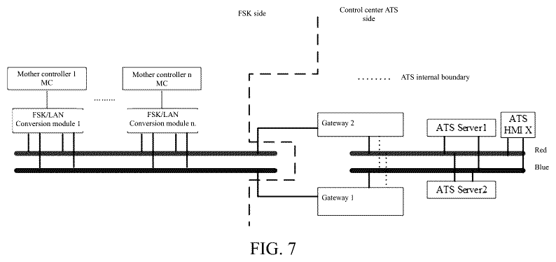

The first Ethernet redundant communication module LAN A and the second Ethernet redundant communication module LAN B are two completely independent modules, which adopt a network communication protocol optimized for a specific application of a project and based on a standard Modbus TCP/IP. A connection architecture between them and an upper ATS system is shown in FIG. 7.

The Ethernet redundant communication module A/B has the following main functions:
(a) Each of the two modules have two physical connections with a redundant red and blue Ethernet respectively, so as to ensure that two redundant communication channels are still maintained with the ATS system of the control center in a case of a single module fault, that is, the FSK/LAN module and an ATS gateway computer maintain four independent IP continuous communications, with a communication cycle being 1000 ms;
(b) Under the Modbus standard communication protocol architecture, the ATS acts as a client to initiate communication, and the FSK/LAN module acts as a server to respond to an ATS request;
(c) Read (TK) and write (TC) operations are separated, and only one master IP from 4IPs reads and writes at the same time at a timing, and an ATS instruction is delivered to the MC to ensure the uniqueness of an MC device write operation, and the remaining 3 IPs only feed back an MC state to the ATS in response to an ATS read request;
(d) When the master IP is switched due to a communication network fault, the FSK/LAN module would automatically respond to the switch of an ATS write request and switch the master communication IP.

The main functions of the system configuration and maintenance module MAN are as follows:
(a) Refreshing a program for an FPGA programmable logic device and other devices in the FSK/LAN module;
(b) By connecting to a PC diagnostic software over a network or a serial port, monitoring input and output interfaces in real time, and bypassing an ATS input to force the interface to output specific control code bits. This function is mainly used for on-site interface debugging and fault diagnosis.

The apparatus further comprises an external interface which specifically comprises:
(1) 4 mutually independent Ethernet interfaces with the ATS gateway of the control center, which have a speed of 100 Mbps and are connected via a switch based on a redundant ring network architecture; and
(2) two mutually independent FSK communication interfaces with a station MC cabinet, which have a transmission period of 770 ms and are respectively as follows;
(a) Control command TC=1.8 kHz+/−200 Hz;
(b) State feedback TK=1.8 kHz+/−200 Hz.

The present invention is developed for the specific application scenario of the Mexico metro line 1 to line 6. However, the complete set of rail transit running system device of the France SGTE Systemes & Services company has a wide range of application performance in the world. Mexico metro line 1 to line 9 and line A, total of 10 lines, early rail transit projects in Sao Paulo in Brazil, Santiago in Chile, Buenos Aires in Argentina and other cities are using the system. The successful development and application of the FSK/LAN module provides a feasible option for the segmental transformation of the above urban rail transit, that is, the ATS system transformation of the control center is implemented first, and then the CBTC whole system transformation is gradually implemented.

The above are only specific embodiments of the present invention, but the protection scope of the present invention is not limited to this, and any technical person familiar with the technical field can easily think of various equivalent modifications or replacements within the technical scope disclosed by the present invention, and these modifications or replacements shall be covered by the protection scope of the present invention. Therefore, the protection scope of the present invention shall be subject to the protection scope of the claims.

1. An FSK and LAN protocol conversion apparatus for a rail transit signal system, wherein the apparatus comprises:
a control instruction sending module (TC);
a device state receiving module (TK);
a data validity check module (VD) connected with the control instruction sending module (TC) and the device state receiving module (TK) respectively;
a first Ethernet redundant communication module (LAN A) connected with the data validity check module (VD);
a second Ethernet redundant communication module (LAN B) connected with the data validity check module (VD); and
a system configuration and maintenance module (MAN) connected with the above modules respectively.

2. The FSK and LAN protocol conversion apparatus for a rail transit signal system according to claim 1, wherein the control instruction sending module (TC) comprises:
an information coding and framing sub-module;
an FSK modulation sub-module; and
a D/A conversion sub-module.

3. The FSK and LAN protocol conversion apparatus for a rail transit signal system according to claim 2, wherein a working process of the control instruction sending module (TC) is specifically as follows:
(101) acquiring information data and a check code from the data validity check module;
(102) generating, by the information coding and framing sub-module, a data stream according to a frame format;
(103) performing, by the FSK modulation sub-module, FSK modulation on the generated data stream; and
(104) converting, by the D/A conversion sub-module, the FSK modulated data and sending the converted data to a station MC.

4. The FSK and LAN protocol conversion apparatus for a rail transit signal system according to claim 2, wherein a format of data that the control instruction sending module (TC) sends to the station MC is as follows:
(a) a single information frame contains 28-bit information, including 1 bit of a word start identifier, 20 bits of information bits, 1 bit of a parity check bit, and 6 bits of an information error tolerance code;
(b) 10 single information frames are spliced into 1 complete data packet, and a 28-bit synchronous information packet is added uniformly in a header, and then the obtained packet is sent to the station MC through FSK communication; and
(c) each packet of data has 200 effective information bits, and a transmission cycle is 770 ms.

5. The FSK and LAN protocol conversion apparatus for a rail transit signal system according to claim 3, wherein a specific process of performing, by the FSK modulation sub-module, FSK modulation on the generated data stream is as follows:
an up-sampling process, a molding filtering process, a 3-stage CIC interpolation process, a phase accumulation process and an orthogonal modulation process.

6. The FSK and LAN protocol conversion apparatus for a rail transit signal system according to claim 1, wherein the device state receiving module (TK) comprises:
an information decoding and deframing sub-module;
an FSK demodulation sub-module; and
an A/D conversion sub-module.

7. The FSK and LAN protocol conversion apparatus for a rail transit signal system according to claim 6, wherein a working process of the device state receiving module (TK) is specifically as follows:
(201) receiving data from a station MC, converting, by the A/D conversion sub-module, the received data, and sending the converted data to the FSK demodulation sub-module;
(202) performing, by the FSK demodulation sub-module, FSK demodulation on the received data; and
(203) performing, by the information decoding and deframing sub-module, frame synchronization, bit synchronization and decision decoding in turn on the data obtained through the FSK demodulation.

8. The FSK and LAN protocol conversion apparatus for a rail transit signal system according to claim 7, wherein a specific process of performing, by the FSK demodulation sub-module, FSK demodulation on the received data is as follows:
a down-conversion process, a low-pass filtering process, a matching filtering process, a 3-stage CIC extraction process, a phase-locked loop process and a baseband signal generating process.

9. The FSK and LAN protocol conversion apparatus for a rail transit signal system according to claim 7, wherein the frame synchronization in (203) is specifically as follows:
calculating correlation values between baseband signal samples outputted by a phase-locked loop and a synchronization sequence to find a synchronization position.

10. The FSK and LAN protocol conversion apparatus for a rail transit signal system according to claim 7, wherein the bit synchronization in (203) is specifically as follows:
performing the bit synchronization according to a frame synchronization position to obtain complete data of 11 words.

11. The FSK and LAN protocol conversion apparatus for a rail transit signal system according to claim 7, wherein the decision decoding in (203) is specifically as follows:
performing a decoding operation, and delivering information bits and check bits of 10 words from word 2 to word 11 to the data validity check module for processing.

12. The FSK and LAN protocol conversion apparatus for a rail transit signal system according to claim 1, wherein the data validity check module (VD) comprises:
a data error tolerance code generating sub-module; and
a data error tolerance code check sub-module.

13. The FSK and LAN protocol conversion apparatus for a rail transit signal system according to claim 12, wherein the data error tolerance code generating sub-module divides acquired instruction information into 10 words according to an MC framing manner, generates 6-bit check bits for each word by a generating polynomial according to a fixed coding rule, and then splices the information and uniformly sends the spliced information to the control instruction sending module (TC) for a framing operation.

14. The FSK and LAN protocol conversion apparatus for a rail transit signal system according to claim 12, wherein the data error tolerance code check sub-module acquires 10 information words and a 6-bit check code stream per information word from the device state receiving module (TK), implements a data check operation on content of each control word and a corresponding check code according to the generating polynomial, and if the check is correct, discards the 6-bit check code and repackages 200-bit pure data and sends to the Ethernet redundant communication module, and if the check is not correct, sends an all-zero packet to the Ethernet redundant communication module and sets an identification bit to identify a data check error.

15. The FSK and LAN protocol conversion apparatus for a rail transit signal system according to claim 1, wherein the first Ethernet redundant communication module (LAN A) and the second Ethernet redundant communication module (LAN B) are two completely independent modules, each of which has two physical connections with a redundant red and blue Ethernet, so as to ensure that two redundant communication channels are still maintained with an ATS system of a control center in a case of a single module fault; and
the FSK and LAN protocol conversion apparatus maintains 4 independent IP continuous communications with an ATS gateway computer at the same time.

16. The FSK and LAN protocol conversion apparatus for a rail transit signal system according to claim 15, wherein read and write operations of the first Ethernet redundant communication module (LAN A) and the second Ethernet redundant communication module (LAN B) are separated, and only one master IP from 4 IPs reads and writes at the same time at a timing, and an ATS instruction is delivered to the MC to ensure the uniqueness of an MC write operation, and the remaining 3 IPs only feed back an MC state to the ATS in respond to an ATS read request.

17. The FSK and LAN protocol conversion apparatus for a rail transit signal system according to claim 1, wherein the system configuration and maintenance module (MAN) is used to refresh an internal component of the apparatus, and the MAN connects diagnostic software of a PC through a network or a serial port to monitor an input or output interface of each module in real time, and bypasses an ATS input to force the interface to output specific control code bits.

18. The FSK and LAN protocol conversion apparatus for a rail transit signal system according to claim 1, wherein the apparatus further comprises an external interface which specifically comprises:
4 mutually independent Ethernet interfaces with an ATS gateway of a control center; and two mutually independent FSK communication interfaces with a station MC cabinet.
